(19) United States
(12) Patent Application Publication
(10) Pub. No.: US 2015/0154484 A1
(43) Pub. Date: Jun. 4, 2015

(54) PRINTING SYSTEM, INFORMATION PROCESSING DEVICE, NON-TRANSITORY COMPUTER READABLE MEDIUM, AND IMAGE FORMING DEVICE

(71) Applicant: FUJI XEROX CO., LTD, TOKYO (JP)

(72) Inventors: Manabu IWASAKI, Kanagawa (JP); Shin OHTAKE, Kanagawa (JP)

(73) Assignee: FUJI XEROX CO., LTD, TOKYO (JP)

(21) Appl. No.: 14/295,741

(22) Filed: Jun. 4, 2014

(30) Foreign Application Priority Data
Dec. 4, 2013 (JP) 2013-250856

(51) Int. Cl. G06K 15/00

(52) U.S. Cl. CPC G06K 15/4095

(57) ABSTRACT

A printing system includes an information processing device and an image forming device. The information processing device includes an authentication request unit, an authorization information acquisition unit, and a transfer unit. The authentication request unit requests user authentication. The authorization information acquisition unit acquires access authorization information from a print service system in response to successful authentication of a user in the print service system. The transfer unit transfers the acquired access authorization information to the image forming device via short-range communication. The image forming device includes a transmitting unit. The transmitting unit transmits a setting request to a print service system to request the print service system to set a setting to allow a user associated with the access authorization information to use the image forming device.

### CROSS-REFERENCE TO RELATED APPLICATIONS

This application is based on and claims priority under 35 USC 119 from Japanese Patent Application No. 2013-250856 filed Dec. 4, 2013.

### BACKGROUND

(i) Technical Field

The present invention relates to a printing system, an information processing device, a non-transitory computer readable medium, and an image forming device.

(ii) Related Art

In recent years, cloud print services provided over the Internet, such as Google Cloud Print (registered trademark), which is designed by Google (registered trademark) Inc., have been proposed. A user logs into a cloud print service from a personal computer (PC) or a similar device using a user ID for the service. After login, the user sends print data to the cloud print service, and then the print data is provided from the cloud print service to an image forming device via the Internet or the like for printing.

Before utilizing a public cloud print service such as Google Cloud Print, users register with the cloud print service in advance and register functionality information on image forming devices that the users use. A user logs into the print service, specifies a document to be printed, and further selects one of previously registered image forming devices as the destination from which the user will print or output the document. In response to the selection of the destination, the print service converts the document to be printed into print data of a predetermined print data format such as Portable Document Format (PDF), and provides the print data to the selected image forming device to print the print data.

It may be beneficial to register an image forming device that a user usually uses (for example, a home printer) on a cloud print service in the manner described above in association with the user's account. Such registration allows the user to print or output from the image forming device once they log into the cloud print service with their account and issue a print instruction.

However, it may be problematic to register an image forming device owned or managed by another user, such as an image forming device at a store in the street such as a convenience store or at a place where a user stops by (e.g., a different department of the company to which the user belongs, a customer, etc.). The registration of an image forming device on a cloud print service is generally permanent, and continues unless the registration is cancelled (in the case of Google Cloud Print, for example). Thus, the owner or administrator of an image forming device would not generally permit an outsider to register the image forming device on a cloud print service.

In the case of Google Cloud Print, the share function allows the owner or administrator of an image forming device to permit other persons to use the image forming device that the owner or administrator has registered on Google Cloud Print. For example, a user who wishes to perform printing via a cloud print service from an image forming device at a place the user will visit may ask the owner or administrator of the image forming device at the place to be visited to perform setting to share an account in advance, thereby being able to output from the image forming device using the account of the owner or administrator via the cloud print service.

### SUMMARY

According to an aspect of the invention, there is provided a printing system including an information processing device and an image forming device. The information processing device includes an authentication request unit, an authorization information acquisition unit, and a transfer unit. The authentication request unit requests an authentication of a user in a print service system using identification information identifying the user in the print service system and authentication information for authenticating the identification information identifying the user. The authorization information acquisition unit acquires, in response to success of the authentication, access authorization information associated with the identification information identifying the user from the print service system. The transfer unit transfers the acquired access authorization information to the image forming device via short-range communication. The image forming device includes a transmitting unit. The transmitting unit transmits a setting request to the print service system to request the print service system to set a setting to allow a user associated with the access authorization information to use the image forming device, the setting request including the access authorization information transferred from the information processing device and identification information identifying the image forming device in the print service system.

### BRIEF DESCRIPTION OF THE DRAWINGS

An exemplary embodiment of the present invention will be described in detail based on the following figures, wherein:

FIG. 1 is a diagram illustrating an example configuration of a system according to an exemplary embodiment;

FIG. 2 illustrates an example of the flow of a process according to the exemplary embodiment;

FIG. 3 illustrates an example functional configuration of an image forming device;

FIG. 4 illustrates an example functional configuration of a mobile terminal;

FIG. 5 illustrates an example functional configuration of a cloud print service;

FIG. 6 illustrates an example of the procedure for a process of the cloud print service according to a first exemplary modification;

FIG. 7 illustrates an example of the procedure for a lock setting/cancellation process of the cloud print service according to a second exemplary modification;

FIG. 8 illustrates an example of the procedure for a user print instruction reception process of the cloud print service according to the second exemplary modification;

FIG. 9 illustrates an example of the flow of a process according to a third exemplary modification; and

FIG. 10 illustrates an example of the flow of a process according to a fourth exemplary modification.

### DETAILED DESCRIPTION

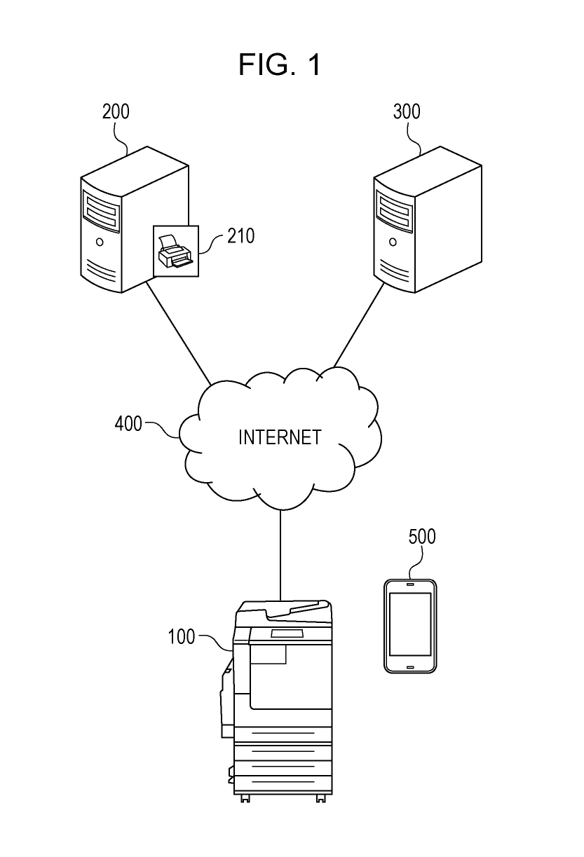

An example configuration of a system according to an exemplary embodiment will be described with reference to FIG. 1. The illustrated system includes an image forming device 100, a cloud print service 200, a cloud repository service 300, and a mobile terminal 500 that a user carries. The image forming device 100, the cloud print service 200, and the cloud repository service 300 may communicate with one another via the Internet 400.

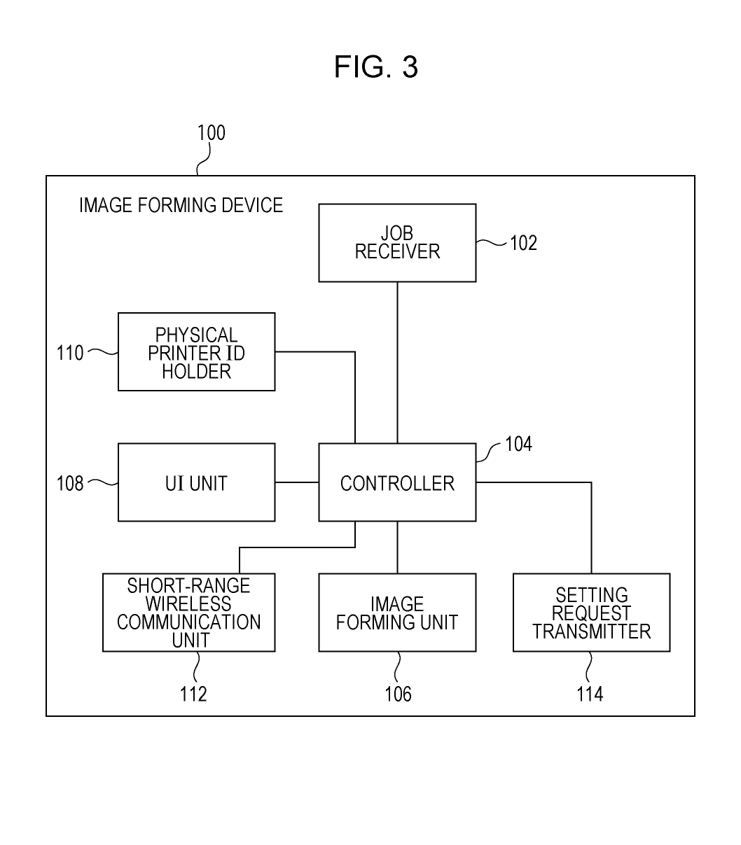

The image forming device 100 is configured to print input print data onto a sheet of paper. The image forming device 100 may have functions other than the printing function. For example, the image forming device 100 may be a digital multifunction device having a scanning function, a copying function, a facsimile transmission function, and an electronic mail transmission function in addition to the printing function. The image forming device 100 has a function to execute processing such as copying, scanning, and printing in accordance with a user instruction received at a user interface (UI) unit 108 (see FIG. 3), and also has a function to acquire print data from the cloud print service 200 on the Internet 400 and to print or output the print data. The image forming device 100 may also be connected to an in-house network of a company or the like. In this case, the image forming device 100 has a function to execute processing such as printing in accordance with an instruction from a computer connected to the in-house network.

The image forming device 100 also has a function to support cloud printing, that is, a function to execute a printing process using the cloud print service 200. Examples of the function to support cloud printing include a function to register with the cloud print service 200 to receive an assigned physical printer ID (described below), and a function to communicate with the cloud print service 200 in accordance with various protocols to receive print data for which the image forming device 100 is designated as the output destination. If the image forming device 100 does not support cloud printing, a cloud printing enabled computer, such as a personal computer (PC), may be connected to the image forming device 100. In this case, the connected computer communicates with the cloud print service 200 as a proxy, or on behalf of the image forming device 100, and passes the print data acquired from the cloud print service 200 to the image forming device 100 to print.

The cloud print service 200 is a system configured to provide a user with a print service over a network such as the Internet via cloud computing. The cloud print service 200 is generally a system constructed with multiple computers, or may be constructed with a single computer. For example, Google Cloud Print is an example of the cloud print service 200.

The cloud print service 200 provides users with functions, examples of which include a function to convert document data designated as the object to be printed by a user (which has been created using, for example, word processor or spreadsheet software) into print data in a print data format processible by the image forming device 100 (for example, a page description language format such as PostScript (registered trademark) or PDF format), and a function to generate a print job corresponding to a received print instruction to manage the state and the like of execution of the print job (for example, queue management). The cloud print service 200 generates and manages a logical printer (also referred to as a printer object) 210 that implements functionality for a print service. The logical printer 210 registers one or more users who use the logical printer 210. For example, the logical printer 210 registers a user ID of a user who has designated an instruction to create the logical printer 210 as administrator attribute information on the logical printer 210. The administrator is authorized to set a sharer with which the logical printer 210 is sharable. The user ID of the set sharer is held in the logical printer 210 as sharer attribute information.

The cloud print service 200 generally holds multiple logical printers 210. Each of the logical printers 210 is used by one or more users (administrators or sharers) who have registered with the logical printer 210.

The logical printer 210 may also register one or more physical output destination printers (called “physical printers”, for example, the image forming device 100 illustrated in FIG. 1) to which print jobs held in a queue in the logical printer 210 are output. In this case, the logical printer 210 holds management information concerning the registered physical printer or printers. The management information may include, for example, information identifying the corresponding physical printer (for example, a unique physical printer ID assigned by the cloud print service 200 or an Internet protocol (IP) address of the physical printer), capability information indicating the capabilities (or functions) of the corresponding physical printer, and so forth. The capability information may include information such as whether or not duplexing printing is enabled, whether or not full-color printing is enabled, and the size of paper in the corresponding physical printer. When the corresponding physical printer includes a post-processing device, the capability information may also include information concerning the capabilities of the post-processing device (such as stapling, hole punching, and folding).

A user registers (or creates) their account on the cloud print service 200. When creating an account, a user registers a unique user ID on the cloud print service 200. In the case of Google Cloud Print, a Google account, which is an account for general services provided by Google Inc., is used as the account (user ID) of the user for Google Cloud Print.

The cloud print service 200 creates a logical printer 210 in accordance with an instruction given by a user. The cloud print service 200 stores, for each logical printer 210, a user ID of a user who has been registered as a user who is authorized to use the logical printer 210. In addition, in accordance with an instruction given by a user who has the privilege of user registration on an existing logical printer 210, a user who is authorized to use the existing logical printer 210 may be allowed to register with the existing logical printer 210 (share settings).

A user logs into the cloud print service 200 with their user ID over the Internet 400 from a device connected to the Internet 400, such as a PC, a mobile terminal, or the image forming device 100, using a communication protocol such as Hypertext Transfer Protocol (HTTP), and sends a print instruction to a logical printer 210 selected from among one or more logical printers 210 associated with the user ID. The print instruction includes document data to be printed or information that specifies the object to be printed, such as information that identifies the document data (for example, information on a storage location (e.g., Uniform Resource Locator (URL)) of the document data over the Internet 400). The document data may reside in, for example, the cloud repository service 300 described below. The logical printer 210 generates a print job in accordance with the print instruction, and manages the generated print job. A print job is the unit by which a print instruction is managed in the logical printer 210, and is assigned a unique job ID. The logical printer 210 manages, in association with a job ID, information such as information of the document data to be printed, print data of a page description language format or the like which is obtained by converting the document data, a user ID of a user who has issued the print instruction, and the state of execution (for example, unexecuted, being executed, execution completed, or error) of the print job.

The logical printer 210 provides print data held therein to an output destination physical printer specified by a user to print or output the print data from the physical printer. The print data may be provided in such a manner that the print data is directly transmitted in push mode from the logical printer 210 to the physical printer, or may be provided in pull mode. In pull mode, a message including information that identifies the print data is transmitted to the physical printer, and a print job is provided to the physical printer in response to an HTTP acquisition request or the like from the physical printer upon receipt of the message. The pull printing mode is used, for example, in the case of printing a print job for the logical printer 210 using the image forming device 100 within an internal network that is protected from the Internet 400 by a firewall.

A user who wishes to use a physical printer for printing in the cloud print service 200 registers the physical printer on the cloud print service 200. This registration operation allows the cloud print service 200 to identify and authenticate the physical printer. For example, a physical printer and the cloud print service 200 have common knowledge of information identifying the physical printer, and the physical printer presents information identifying the physical printer (and, if necessary, authentication information for verifying the authenticity of the physical printer) to the cloud print service 200, thereby being able to access the cloud print service 200.

In the case of Google Cloud Print, a user who has a Google account registers themselves on a web page for physical printer registration while login with the Google account. Then, Google Cloud Print issues a physical printer ID (“printer_id”) that uniquely identifies the physical printer to be registered. The physical printer ID is saved in the physical printer to be registered or in a computer such as a PC operating as a proxy of the physical printer. Google Cloud Print stores the physical printer ID assigned to the registered physical printer in association with the account of the user. Accordingly, the user who has performed the registration operation is recognized as the administrator of the physical printer. Google Cloud Print sets the physical printer ID for the logical printer 210 associated with the user as one of the available printers. The physical printer or the proxy connected thereto presents the physical printer ID held therein to the cloud print service 200, thereby verifying itself as being a registered physical printer and acquiring a print job held in the logical printer 210 associated with the physical printer.

An administrator of a physical printer applies share settings to the logical printer 210 of the administrator, thereby permitting any other user registered on the cloud print service 200 to use the logical printer 210 and a physical printer registered as an output destination for the logical printer 210.

The cloud repository service 300 is a system configured to provide users with a repository service over the Internet 400. The repository service is a preservation service for data, programs, and so forth, and is also referred to as an online storage service. The cloud repository service 300 is generally a system constructed with multiple computers, or may be constructed with a single computer. Examples of the cloud repository service 300 include Google Docs (trademark), Dropbox (trademark), and Evernote (trademark).

The cloud repository service 300 archives, for example, for each user, various files uploaded from the user, such as document data and programs, and provides the archived files to the user. A user registers with the cloud repository service 300 to acquire a unique user ID for the service 300. The user logs into the service 300 using the user ID to upload or download a file. In services linked with each other in terms of user authentication, such as Google Cloud Print and Google Docs, a user logs into the account of a first service (or logs into a general account that covers all these services, such as a Google account), thereby being able to use a linked second service from the first service. In the following description, for simplicity of illustration, the cloud repository service 300 and the cloud print service 200 are linked with each other in terms of user authentication.

The mobile terminal 500 is an information processing device that a user carries. Examples of the mobile terminal 500 include a smartphone, a tablet terminal, and a mobile phone. The mobile terminal 500 is capable of access to services on the Internet 400, such as the cloud print service 200. The mobile terminal 500 has installed therein an application (hereinafter referred to as a “cloud print app”) that serves as a user interface (UI) through which the user sends a print instruction to the cloud print service 200.

In the illustrated example, a user who carries the mobile terminal 500 has an account for the cloud print service 200. In addition, the image forming device 100 has been registered on the cloud print service 200 by the administrator, and has been assigned a physical printer ID. Note that in the illustrated example, the user who carries the mobile terminal 500 is different from the administrator of the image forming device 100 registered on the cloud print service 200. In this case, the user is authorized to use the cloud print service 200 from the mobile terminal 500. However, in the related art, the user is not allowed to designate the image forming device 100 as an output destination (so long as the share settings described above have not been applied).

The following is a description of a mechanism in which a user who carries the mobile terminal 500 performs printing using the image forming device 100 as an output destination via the cloud print service 200 in the situation described above.

In this mechanism, the settings for allowing the user of the mobile terminal 500 to not permanently, or temporarily, use an image forming device 100 located at a site to be visited or the like are applied to the cloud print service 200. The settings described above are referred to as “temporary printer settings”. In the temporary printer settings, setting information including the correspondence between the user ID of the user and the physical printer ID of the image forming device 100 and indicating that the user is authorized to use the image forming device 100 is registered on the cloud print service 200.

For example, the setting information may be registered on a database that is searchable using a user ID or a physical printer ID as a search key. In this case, upon designation of an output destination physical printer by a user, the cloud print service 200 checks whether or not the correspondence between the user and the physical printer has been registered on the database. If the correspondence has been registered, the cloud print service 200 determines that the user is authorized to perform printing using the physical printer.

In another example, the setting information may be stored in the logical printer 210. Specifically, a logical printer 210 as whose administrator or sharer the user of the mobile terminal 500 is set and in which the image forming device 100 is designated as a candidate output destination is prepared in the cloud print service 200. The correspondence between the user ID of the user set as an administrator or a sharer and the physical printer ID of the image forming device 100 set as a candidate output destination corresponds to the setting information described above. The following description will be given taking as a representative example this method, that is, a method in which setting information for allowing the user of the mobile terminal 500 to use the image forming device 100 is stored in the logical printer 210.

There are some specific implementations of the temporary printer settings in the method described above. In one example, in temporary printer settings, a new logical printer 210 in which the physical printer ID is set as a candidate output destination is created. In this example, in the newly created logical printer, the user ID of the user who performs the temporary printer settings (i.e., the user of the mobile terminal 500) is set as an administrator attribute. In another example, the physical printer ID may be registered as a candidate output destination on an existing logical printer 210 in which the user ID has been set as an administrator. These settings involve creating or modifying a logical printer whose administrator is the user, which falls within user's normally privileged actions.

In still another example, if the administrator of the image forming device 100 permits in advance, the temporary printer settings may involve setting, for a logical printer 210 on which the administrator has administrative privileges (a logical printer 210 that has registered the physical printer ID of the image forming device 100 as the output destination), as a user (sharer) who is authorized to use the logical printer, the user ID of the user. The administrator of the image forming device 100 applies settings to the logical printer 210 of the administrator, in which the image forming device 100 within the cloud print service 200 is designated as the output destination, so that, for example, the share settings are permitted for any user, thereby enabling temporary printer settings to be performed in this implementation. Instead of the share settings for the logical printer 210 of the administrator of the image forming device 100 being unconditionally permitted for “any” user, the share settings may be permitted only through a setting request described below (i.e., a setting request including the user ID of the requesting user and the physical printer ID of the image forming device 100 set as the output destination of the logical printer 210).

The settings for making a physical printer usable, such as the temporary printer settings, are generally made by a user who has logged into the cloud print service 200. In this exemplary embodiment, in contrast, a user who has the privileges of the temporary printer settings transfers the privileges to the image forming device 100 from the mobile terminal 500. The image forming device 100 that has inherited the privileges accesses the cloud print service 200 with the privileges, and executes a process to perform settings so that the user will be able to use the image forming device 100.

In the following example, by way of example, privileges may be granted via OAuth. OAuth is a protocol for providing desktop computers, mobile terminals, web applications, and so forth with a standard model for secure application programming interface (API) authorization. OAuth is merely an example, and any other protocol capable of implementing similar privilege transfer may be used.

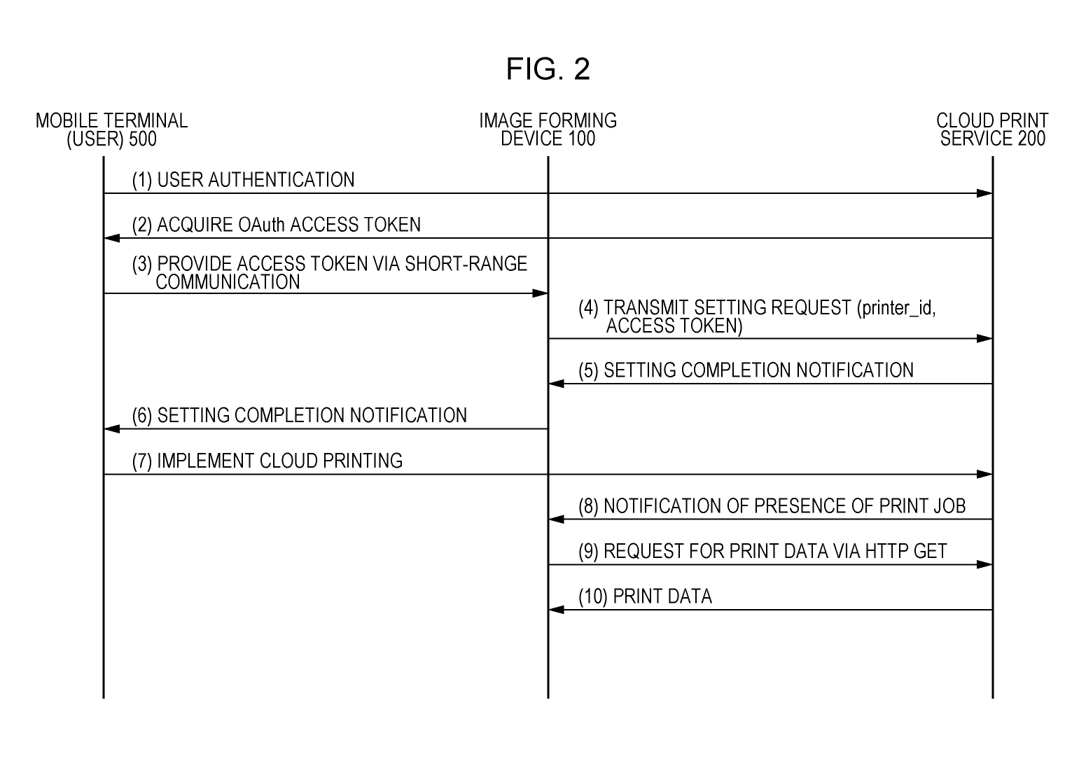

FIG. 2 illustrates the flow of a process for printing or outputting print data from the mobile terminal 500 to the image forming device 100 via the cloud print service 200.

In process step (1), when a user who carries the mobile terminal 500 wishes to use an image forming device 100 located at a site to be visited, first, the user accesses the cloud print service 200 from the mobile terminal 500 via the Internet 400, and requests user authentication in the cloud print service 200. In an example, when a cloud print app is booted on the mobile terminal 500, the cloud print app accesses the cloud print service 200, and requests user authentication in the cloud print service 200 using authentication information stored in the mobile terminal 500, such as the user ID and password of the user. Instead of the user ID being saved in the mobile terminal 500, the user may enter the user ID for user authentication.

In process step (2), when the user authentication is successful, the user is authorized to perform various operations on the cloud print service 200 using the cloud print app. Then, the user acquires an OAuth access token to transfer the privileges of the temporary printer settings operation.

For example, when the user selects the “temporary printer settings” operation from an operation menu of the cloud print app, the cloud print app requests the cloud print service 200 to issue an access token for transferring the privileges of the temporary printer settings possessed by the user. In response to the request, the cloud print service 200 generates an access token. The access token is, for example, a data value including authorization information that specifies the content of authorization for a person who presents the access token. The authorization information is information including, for example, the user ID of the user in the cloud print service 200, and information indicating the access privileges of the temporary printer settings provided by the cloud print service 200 for an API. The authorization information may be encrypted to produce a character string that appears at random, and the character string may be used as an access token. Instead of authorization information being included in an access token, authorization information which is assigned identification information may be saved in the cloud print service 200, and the identification information assigned to the authorization information may be used as an access token. In any method, once an access token is presented to the cloud print service 200, the cloud print service 200 is able to obtain authorization information associated with the access token. An access token or authorization information may be managed in association with date information such as the date and time of issuance or the expiration time. When a predetermined amount of time has passed since the date and time of issuance or when the expiration time has passed, the access token may be invalidated.

The cloud print service 200 returns the generated access token to the cloud print app in the mobile terminal 500 in response to the request.

In process step (3), upon acquisition of the access token, the cloud print app transfers the access token to the image forming device 100 via short-range communication. The short-range communication may be based on short-range wireless communication technologies such as near field communication (NFC), Bluetooth (registered trademark), or WiFi. The short-range communication may also be based on short-range non-wireless communication technologies that use transmission media, such as infrared communication.

Other examples of the short-range communication include a technology in which an access token displayed on a screen of the mobile terminal 500 is captured with a camera provided in the image forming device 100 to transfer the access token. In this case, the access token may be displayed in any style. For example, the access token may be displayed on the screen as an image code such as a QR (registered trademark) code or a barcode, or may be displayed on the screen as a character string. The image forming device 100 analyzes the captured image using an analysis algorithm in accordance with the display style of the access token to determine the value of the access token. This technology is common to technologies that use NFC, infrared communication, and the like in that a user goes to the image forming device 100 with the mobile terminal 500 and places the mobile terminal 500 near the image forming device 100 to connect the mobile terminal 500 and the image forming device 100 to each other.

By way of example, NFC is used as a short-range communication method. In a case, for example, the user of the mobile terminal 500 goes to the place where the image forming device 100 is located and performs process steps (1) and (2) described above. Then, the user touches an NFC reader/writer unit of the image forming device 100 using the mobile terminal 500 so that the access token stored in the mobile terminal 500 is transferred to the image forming device 100. Upon acquisition of the access token, the cloud print app may display a touch operation navigation image on the screen of the mobile terminal 500 to prompt the user to perform this touch operation.

In another example, process steps (1) and (2) described above may be performed in response to a user's touch of the mobile terminal 500 on the reader/writer unit of the image forming device 100 for NFC communication as a trigger. That is, when the user touches the reader/writer unit of the image forming device 100 using the mobile terminal 500, for example, a notification that “this device (the image forming device 100) is a printer” (or is a printer made temporarily usable by the mechanism according to this exemplary embodiment) is transmitted from the image forming device 100 to the mobile terminal 500 via NFC communication. Upon receipt of the notification, an operating system (OS) of the mobile terminal 500 starts the cloud print app (or the access token acquisition function for the temporary printer settings). Then, the cloud print app or the access token acquisition function implements process steps (1) and (2) described above to acquire an access token from the cloud print service 200. Then, in process step (3) described above, for example, the user places the mobile terminal 500 near the reader/writer unit once again in accordance with the display of the navigation screen, thereby sending the access token from the mobile terminal 500 to the image forming device 100 via NFC communication. In the illustrated example, the touch operation is performed twice to start software such as the cloud print app and to transfer the access token. However, those two operations may be executed during a single touch operation.

In process step (4), upon receipt of the access token, the image forming device 100 generates a setting request including the acquired access token and the physical printer ID of the image forming device 100, and transmits the setting request to the cloud print service 200 via the Internet 400. The data format of the setting request is determined by the cloud print service 200 in advance. The image forming device 100 generates a setting request in accordance with the determined data format.

Upon receipt of the setting request from the image forming device 100, the cloud print service 200 performs the temporary printer settings described above in accordance with the setting request. Specifically, first, the cloud print service 200 extracts the access token from the setting request, and acquires authorization information associated with the access token. The authorization information indicates a user ID and also indicates that the user who has the user ID authorizes the temporary printer setting function. In accordance with the authorization information, the cloud print service 200 registers setting information for associating the physical printer ID (the image forming device 100) included in the setting request as a candidate output destination with the user ID included in the authorization information. In the illustrated example, as described above, a logical printer 210 having the setting information is prepared by being newly created or by modifying an existing logical printer 210.

The setting process described above allows a user who carries the mobile terminal 500 to perform printing using the image forming device 100 via the cloud print service 200. In the example described above, furthermore, the cloud print service 200 issues an OAuth access token to transfer the privileges of the temporary printer setting operation. However, the exemplary embodiment disclosed herein is not limited to this example. In an example, identification information indicating provisional registration of a printer may be issued instead of a token, and the identification information of the provisional registration of a printer may be received from the image forming device 100.

In process step (5), when the setting process is completed, the cloud print service 200 returns a notification of completion of setting to the image forming device 100 in response to the setting request in process step (4).

In process step (6), upon receipt of the setting completion notification, the image forming device 100 notifies the mobile terminal 500 of completion of setting via NFC communication. This notification may be transmitted in response to the transmission of the access token in process step (3) described above. For example, when the user touches the reader/writer unit of the image forming device 100 using the mobile terminal 500 to in process step (3), process steps (3) to (6) may be performed during the touch period. In this case, a message corresponding to the notification may be displayed on the screen of the mobile terminal 500, allowing the user to know that the image forming device 100 has become usable.

Then, in process step (7), the user accesses the cloud print service 200 from the mobile terminal 500, and sends a print instruction to the cloud print service 200. For example, the user starts the cloud print app on the mobile terminal 500 and logs into the cloud print service 200. Then, a list of logical printers 210 that the user is authorized to use (i.e., logical printers that have registered the user as an administrator or a sharer) is provided. The list also includes a logical printer 210 associated with the image forming device 100 that has been set so that the user is authorized to use the image forming device 100 in process step (4). The user selects a logical printer 210 that the user will use from the list on the screen of the cloud print app. Here, the logical printer 210 associated with the image forming device 100 is selected. If there is one logical printer 210 that the user is authorized to use, the selection of a logical printer 210 is omitted.

If multiple available physical printers are set for the logical printer 210 associated with the image forming device 100, a list of such physical printers is provided from the logical printer 210 to the cloud print app. The user selects a physical printer to be used as the current output destination from the list displayed on the cloud print app. Here, the image forming device 100 is selected as the output destination.

The list of logical printers provided by the cloud print service 200 to the mobile terminal 500 may show the name of the owner (or administrator) of each logical printer and the sharing state (whether or not each logical printer is shared, the name of each sharer, etc.).

The cloud print service 200 may hold information on distinction as to whether each logical printer that the user is authorized to use was created using normal registration settings made by a user or using the temporary printer setting function according to this exemplary embodiment, and the logical printer list to be provided to the mobile terminal 500 may include the information on distinction. In this case, when the list is displayed on the mobile terminal 500, which of the two types of logical printers each logical printer is may be displayed. The display of the information on distinction may allow the user to easily select the logical printer associated with the previously temporarily set image forming device 100.

Furthermore, in the method in which the image forming device 100 is additionally set as a candidate output destination for an existing logical printer of the user of the mobile terminal 500 in the temporary printer settings in process step (4) described above, information on distinction indicating that the logical printer has been set using the temporary printer setting function may be set for the logical printer. Also in this case, when a list of logical printers that the user is authorized to use is displayed on the mobile terminal 500, the image forming device 100 registered by the user using the temporary printer setting function may be displayed so as to be distinguishable from an image forming device created using the normal registration setting function. In this case, furthermore, the cloud print service 200 may provide a candidate output destination, which has been additionally registered on the logical printer using the temporary printer setting function, with attribute information indicating that the candidate output destination has been set using the temporary printer setting function. Accordingly, when a screen of a list of output destination physical printers registered on the logical printer is provided to the mobile terminal 500, a physical printer (the image forming device 100) that has been set using the temporary printer setting function may be displayed in a style different from a physical printer that has been registered using the normal registration process. The difference in display style allows the user to identify the image forming device 100 that the user will temporarily use, and to select the image forming device 100 as the output destination.

In addition, in the method in which the user ID of the user of the mobile terminal 500 is registered as a sharer on a logical printer of the administrator of the image forming device 100 in the temporary printer settings in process step (4) described above, the user ID of the user registered as a sharer may be provided with attribute information indicating that the user ID has been registered using the temporary printer setting function. When providing the mobile terminal 500 with a list of logical printers that the user is authorized to use, the cloud print service 200 may display a logical printer as whose sharer the user is set and in which the ID of the user is assigned attribute information indicating that the ID has been registered using the temporary printer setting function, in such a manner that the logical printer is displayed as a logical printer that has been set using the temporary printer setting function so as to be distinguishable from an image forming device that has been created using the normal registration setting function.

In addition, the user designates a document stored in the mobile terminal 500, the cloud repository service 300, or the like as the object to be printed, and issues a print instruction. If the cloud repository service 300 is linked with the cloud print service 200 in terms of authentication, the user logs into the cloud print service 200, thereby being able to acquire a list of documents of the user which are saved in the cloud repository service 300 and to specify the document to be printed from the list.

The logical printer 210 acquires the document to be printed, which has been specified by the user, from the mobile terminal 500, the cloud repository service 300, or the like, and converts the data of the document into a print data format. Instead of the logical printer 210 actively acquiring the document to be printed, the mobile terminal 500 may acquire the document from the cloud repository service 300 or the like and transmit the document to the logical printer 210. Alternatively, the mobile terminal 500 may instruct the cloud repository service 300 to provide the cloud print service 200 with a document to be printed, which is stored in the service 300, and the cloud repository service 300 may transmit the document to the cloud print service 200 in accordance with the instruction. If a document stored in the mobile terminal 500 is specified as the object to be printed, the mobile terminal 500 may transmit the document to the cloud print service 200.

Either specifying the logical printer to be used (and also the output destination physical printer, if necessary) or specifying the document to be printed may be performed first.

In process step (8), if print data of the specified document is prepared, the logical printer 210 sends a message including information that identifies the print data (for example, the URL of the print data) to the image forming device 100 designated as the output destination. In the case of Google Cloud Print, the message is sent using Extensible Messaging and Presence Protocol (XMPP) via the Google Talk service.

In process step (9), upon receipt of the message, the image forming device 100 requests the cloud print service 200 to transmit print data using an HTTP GET request. The request includes information that identifies the print data, which is included in the received message. The request may also include the physical printer ID of the image forming device 100.

In process step (10), in accordance with the request, print data of the document specified by the user in process step (7) is transmitted from the cloud print service 200 to the image forming device 100. The image forming device 100 receives the print data, and prints the print data onto a sheet of paper.

After the execution of printing in process step (10) has been completed, the image forming device 100 may notify the cloud print service 200 of the completion of printing, and, in accordance with the notification, the cloud print service 200 may notify the mobile terminal 500 of the completion of printing. Together with the notification of the completion of printing, the cloud print service 200 may inquire the mobile terminal 500 of whether to continuously print another document. If the user makes a response indicating that the user will not print a document in response to the inquiry, the cloud print service 200 may delete the setting information indicating that the user is authorized to use the image forming device 100.

Next, an example functional configuration of the image forming device 100 configured to execute the process described above will be described hereinafter with reference to FIG. 3. In FIG. 3, portions relevant to the process according to the exemplary embodiment are illustrated, and portions irrelevant to the process according to the exemplary embodiment are not illustrated even though these are elements generally included in an image forming device.

In the image forming device 100, a job receiver 102 communicates with the cloud print service 200 to receive an XMPP message or the like and to receive print data via HTTP in accordance with the message. An image forming unit 106 is a device configured to print an image onto a medium such as a sheet of paper. A controller 104 is a system configured to control the overall operation of the image forming device 100. For example, the controller 104 may instruct an image processor (not illustrated) to convert the print data received by the job receiver 102 from the cloud print service 200 into image data of a format processible by the image forming unit 106, such as raster format, and may supply the image data obtained as a result of conversion to the image forming unit 106 to print the image data onto a medium. The controller 104 further causes, when the image forming device 100 is registered on the cloud print service 200, a physical printer ID sent from the cloud print service 200 to be stored in a physical printer ID holder 110. The user interface (UI) unit 108 is configured to display a screen for receiving an operation performed on the image forming device 100 by a user, or to receive an operation input from a user in accordance with the screen. A short-range wireless communication unit 112 is a device configured to perform communication according to the NFC standard. When the user places the mobile terminal 500, which is an NFC-enabled device, near the reader/writer unit of the image forming device 100, the short-range wireless communication unit 112 detects the NFC-compatible device (the mobile terminal 500). In accordance with the detection, the controller 104 provides the mobile terminal 500 with information or the like indicating that “the image forming device 100 is a printer” via NFC communication. The short-range wireless communication unit 112 is also used for communication when receiving an access token from the mobile terminal 500. A setting request transmitter 114 transmits a setting request to the cloud print service 200. The setting request includes the access token received from the mobile terminal 500, and the physical printer ID held in the physical printer ID holder 110. Accordingly, the cloud print service 200 registers setting information for allowing the user who has the account to use the image forming device 100 associated with the physical printer ID (such as an ID of a user added as a sharer to a new logical printer having the settings described above, or an existing logical printer of the administrator of the image forming device 100).

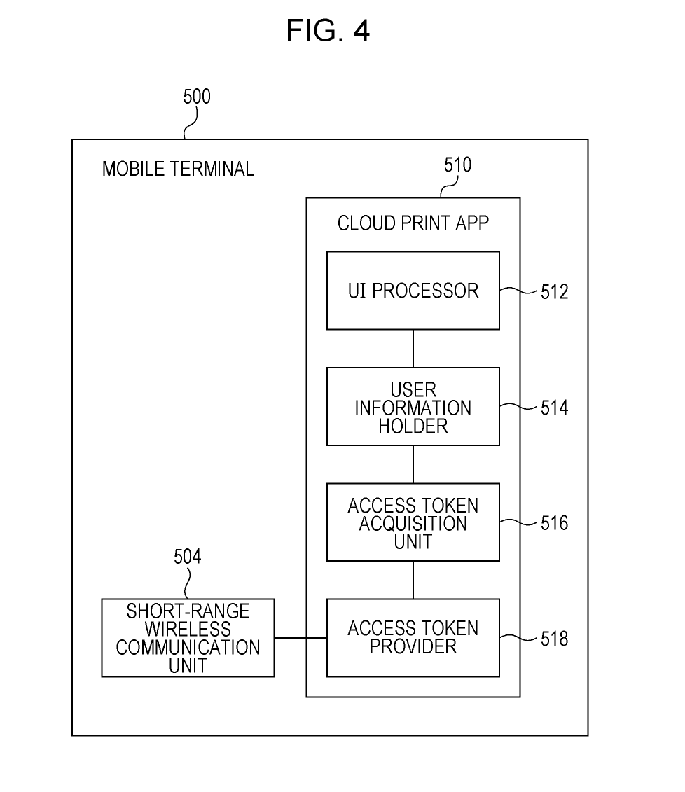

Next, an example of a functional configuration of the mobile terminal 500 configured to execute the process described above will be described with reference to FIG. 4. In FIG. 4, portions relevant to the process according to the exemplary embodiment are illustrated, and portions irrelevant to the process according to the exemplary embodiment are not illustrated even though these are elements generally included in a mobile terminal.

The mobile terminal 500 has a cloud print app 510 installed therein. The cloud print app 510 is an application used for printing from the mobile terminal 500 using the cloud print service 200. The cloud print app 510 includes a UI processor 512 configured to provide a user interface for cloud-based printing. A user information holder 514 holds an account (such as a user ID) of a user who carries the mobile terminal 500 in the cloud print service 200. The information on the account is set in advance by the user. Instead of the cloud print app 510, an OS of the mobile terminal 500 may manage the information on the account.

An access token acquisition unit 516 performs a process for acquiring an access token from the cloud print service 200 via the Internet 400. The access token may be used to transfer the privileges of the temporary printer settings. An access token provider 518 provides the access token acquired by the access token acquisition unit 516 to the image forming device 100 via short-range wireless communication performed by a short-range wireless communication unit 504, such as NFC.

In the mobile terminal 500, when started, the cloud print app 510 accesses the cloud print service 200 on the Internet 400 via a mobile phone line, a wireless network, or the like, and logs into the cloud print service 200 using the account held in the user information holder 514. The UI processor 512 displays a screen showing a list or the like of logical printers of the user, which is provided from the cloud print service 200 in accordance with the login, to prompt the user to select a logical printer to be used from the list. The UI processor 512 generates, in addition to the selection screen for a logical printer, UI screens such as a selection screen for the output destination physical printer, a print settings screen, and a selection screen for the document to be printed in accordance with the information provided from the cloud print service 200, the cloud repository service 300, a file system in the mobile terminal 500, or the like. When the “temporary printer settings” are selected from an operation menu, the UI processor 512 instructs the access token acquisition unit 516 to acquire an access token. In accordance with the instruction, the access token acquisition unit 516 requests the cloud print service 200 into which the user is logging to issue an access token for the temporary printer settings, and acquires the access token issued in accordance with the request. In this way, instead of the user explicitly specifying the “temporary printer settings”, the access token acquisition unit 516 may be started in response to the detection of the image forming device 100 associated with the temporary printer setting function via short-range communication such as NFC, and may execute an access token acquisition process.

When an access token is acquired in the way described above, the access token provider 518 provides the access token to the image forming device 100 via NFC communication performed by the short-range wireless communication unit 504. The access token provider 518 may provide the access token only when the communication partner has been verified, via NFC communication performed by the short-range wireless communication unit 504, as being the image forming device 100 or being an image forming device 100 that supports the temporary printer settings according to this exemplary embodiment.

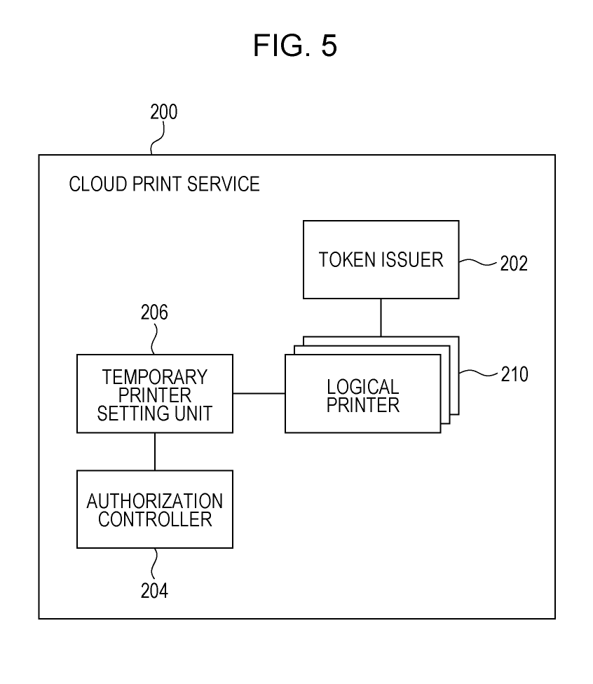

Next, an example of a functional configuration of the cloud print service 200 configured to execute the process described above will be described with reference to FIG. 5. In FIG. 5, portions relevant to the process according to the exemplary embodiment are illustrated, and portions irrelevant to the process according to the exemplary embodiment are not illustrated even though these are elements generally included in a cloud print service.

The cloud print service 200 includes functional modules configured to implement functions according to this exemplary embodiment. The functional modules include a token issuer 202, an authorization controller 204, a temporary printer setting unit 206, and logical printers 210. The logical printers 210 have been described previously. The token issuer 202 issues an access token for authorizing the privileges of the temporary printer settings in accordance with a request from the mobile terminal 500 (process step (2) in FIG. 2). When a setting request (process step (4) in FIG. 2) including the access token is sent from the image forming device 100 that has acquired the access token, the authorization controller 204 authorizes the image forming device 100 to perform the operation to be authorized, which is indicated by the authorization information associated with the access token. In this exemplary embodiment, the access token is used to authorize the privileges of the temporary printer settings. Thus, the authorization controller 204 determines, based on the access token, that the image forming device 100 has the privileges to perform the temporary printer settings on behalf of the user, and instructs the temporary printer setting unit 206 to execute the setting operation responsive to the setting request. In accordance with the instruction, the temporary printer setting unit 206 registers, on the cloud print service 200, setting information for associating the physical printer ID (the image forming device 100) included in the setting request as a candidate output destination with the user ID included in the authorization information.

Next, a description will be given of a first exemplary modification. In this exemplary modification, the cloud print service 200 sets an expiration time for the setting information (setting information for allowing the user of the mobile terminal 500 to use the image forming device 100) set in accordance with the setting request from the image forming device 100 (process step (4) in FIG. 2). Until the expiration time has expired, the cloud print service 200 receives a print instruction from the user that designates the image forming device 100 as the output destination in accordance with the setting information. When the expiration time has expired, the cloud print service 200 invalidates the setting information, and does not accept any print instruction sent from the user that designates the image forming device 100 as the output destination.

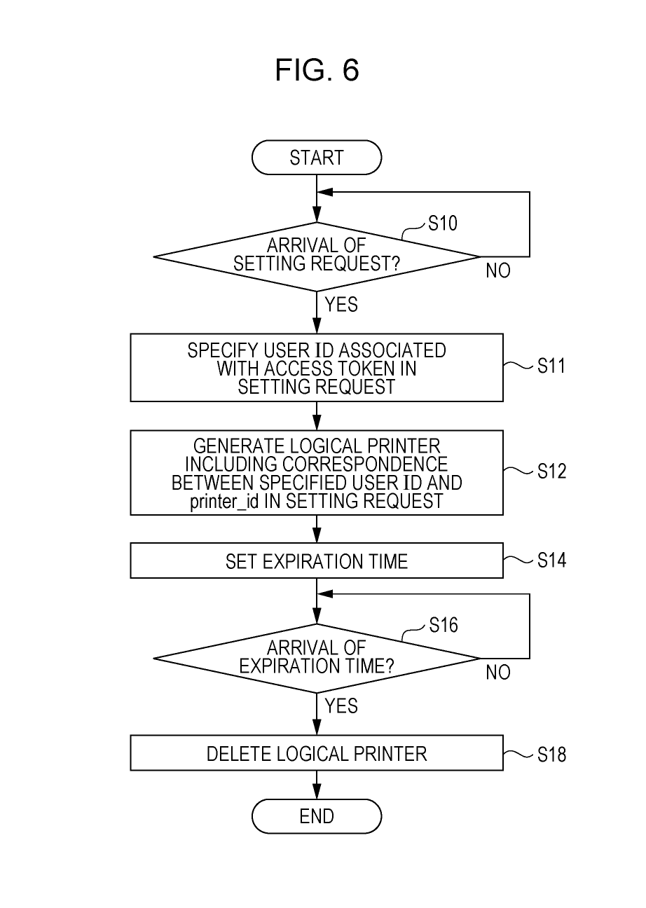

FIG. 6 illustrates an example of the procedure for a process of the cloud print service 200 according to this exemplary modification for allowing the user of the mobile terminal 500 to use the image forming device 100. The processes of the image forming device 100 and the mobile terminal 500 may be similar to those in the exemplary embodiment described above with reference to FIG. 1 to FIG. 4.

In the procedure illustrated in FIG. 6, the cloud print service 200 waits for the arrival of a setting request from the image forming device 100. The setting request includes the physical printer ID (printer_id) of the image forming device 100, and an access token provided by the user of the mobile terminal 500 (S10). When the setting request arrives, the cloud print service 200 acquires authorization information associated with the access token in the setting request from within the access token or from the cloud print service 200, and determines a user ID from the authorization information (S11). Then, the cloud print service 200 generates a new logical printer associated with the user ID, and sets, for the logical printer, the physical printer ID in the setting request as setting information indicating the output destination physical printer (S12). The cloud print service 200 further sets an expiration time for the logical printer generated in S12 (S14). For example, the sum of the amount of a predetermined period of expiry and the time at which the setting request was received may be set as an expiration time. Alternatively, the mobile terminal 500 may receive an expiration time or an expiry period input from the user, and send the input expiration time or the like to the cloud print service 200 together with the setting request, and the cloud print service 200 may set an expiration time for the logical printer in accordance with the expiration time or the like.

There are no particular limitations on how to manage the expiration time. For example, the value of the expiration time may be held in a logical printer as a piece of attribute information, or may be registered on an expiration management table provided outside a logical printer in association with information identifying the logical printer.

After that, the cloud print service 200 checks (for example, periodically), for each logical printer for which an expiration time has been set, whether the expiration time for the logical printer arrives (S16). When the expiration time for a logical printer arrives, the cloud print service 200 deletes the logical printer (S18).

The logical printer generated in S12 is usable by the user who has the user ID contained in the setting request acquired in S10 until it is deleted in S18. The user uses the logical printer during that period of time, thereby being able to print or output print data from the image forming device 100 via the logical printer. When the expiration time has expired, the logical printer disappears. Thus, the setting information that specifies the user as being authorized to use the image forming device 100 is removed from the cloud print service 200, thus preventing the user from printing or outputting print data from the image forming device 100. This mechanism allows the user of the mobile terminal 500 to “temporarily” use the image forming device 100. The administrator of the image forming device 100 may not necessarily explicitly cancel the settings for allowing the user to use the image forming device 100.

A list of logical printers that a user is authorized to use, which is provided by the cloud print service 200 to a device operated by the user (for example, the mobile terminal 500), may include information on the expiration time of each logical printer (such as the date and time of expiry or the remaining expiration time). When viewing the displayed list, the user may identify, based on the expiry of the expiration time limit, a logical printer associated with a physical printer that the user is authorized to use by using the temporary printer setting function from the others.

In the procedure illustrated in FIG. 6, a logical printer of the user of the mobile terminal 500 in which the image forming device 100 is designated as the output destination is newly created. Thus, the logical printer may be deleted when the expiration time arrives. In contrast, in the method in which the user is set share a logical printer of the administrator of the image forming device 100 that has already been present in the cloud print service 200 or the image forming device 100 is additionally set as the output destination for an existing logical printer of the user, the logical printer is difficult to delete even when the expiration time arrives. In this case, when the expiration time arrives, the settings for allowing the user of the mobile terminal 500 to use the image forming device 100 may be deleted from the logical printer. For example, if the user ID of the mobile terminal 500 is set as a sharer for a logical printer of the administrator, the cloud print service 200 may set an expiration time for the set user ID, and delete the setting when the expiration time arrives. Similarly, if the physical printer ID of the image forming device 100 is additionally set as the output destination for an existing logical printer of the user of the mobile terminal 500, the cloud print service 200 may set an expiration time for the additionally set output destination in the logical printer, and delete the additional setting when the expiration time arrives.

Instead of the deletion of a logical printer or setting information in accordance with the arrival of the expiration time, control may be performed without such deletion so that when the user of the mobile terminal 500 accesses the logical printer, the user is not permitted to use the logical printer if the expiration time has expired.

In the first exemplary modification described above, setting information that allows the user of the mobile terminal 500 to use the image forming device 100 is invalidated when the expiration time for the setting information arrives. The trigger for the invalidation of the setting information is not limited to the arrival of the expiration time. Alternatively, after setting the setting information, the cloud print service 200 may cause the image forming device 100 to perform printing in accordance with a print instruction given by the user, and the setting information may be invalidated when the printing operation has been completed. The setting information may also be invalidated in accordance with an explicit instruction given by the user. The invalidation of the setting information may be implemented by the deletion of the setting information or by the addition of invalidity information to the setting information so that the cloud print service 200 does not use the setting information to which the invalidity information is added.

A second exemplary modification will now be described. In this exemplary modification, in accordance with a setting request from the image forming device 100 (process step (4) in FIG. 2), the cloud print service 200 sets setting information for allowing the user of the mobile terminal 500 to use the image forming device 100, and then locks the image forming device 100 as a device for the user only. Specifically, after the setting of the setting information, users other than the user are not allowed to print or output print data from the image forming device 100 via the cloud print service 200 until a predetermined condition is met. The “predetermined condition” that specifies the end of the lock period may be the “expiration time”, which is set in the first exemplary modification. Another example of the “condition” may be that, after the setting information is set, the printing operation performed by the image forming device 100 in accordance with a print instruction given by the user is completed. An explicit input of a lock cancellation instruction given by the user may also be the “condition”.

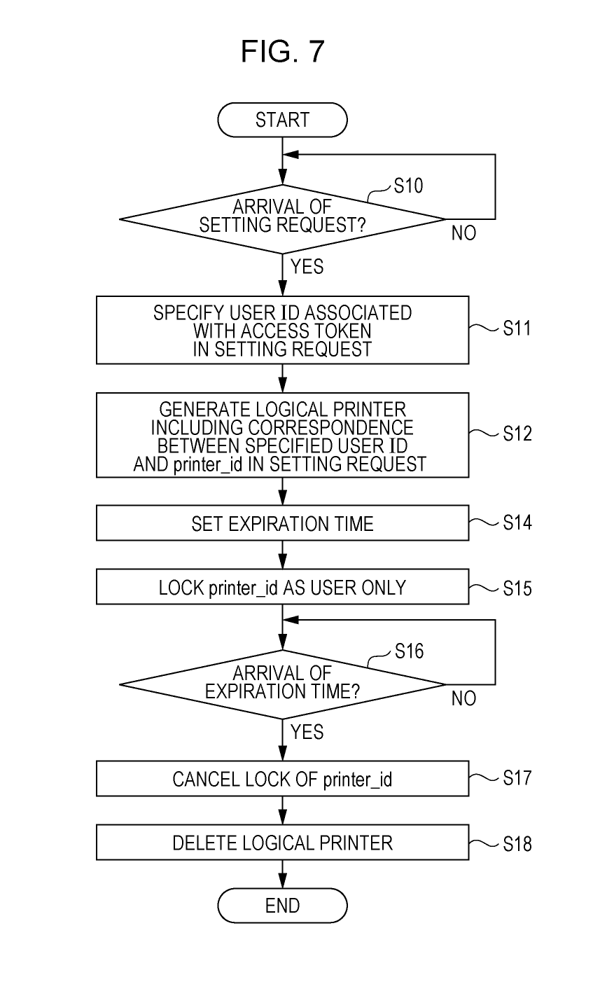

FIG. 7 illustrates an example of the procedure for a lock setting/cancellation process of the cloud print service 200 according to the second exemplary modification. In the illustrated example, the lock is canceled when the “expiration time” has passed. In the procedure illustrated in FIG. 7, process steps similar to those in FIG. 6 are assigned the same numerals, and will not be described.

In the procedure illustrated in FIG. 7, after a logical printer associated with the setting request that arrived in S10 is generated in S12, an expiration time is set for the logical printer (S14). In addition, the physical printer ID (printer_id) included in the setting request is locked as that dedicated to the user ID included in the setting request (S15). The lock setting may be performed by, for example, registering, on a lock management table (not illustrated) held in the cloud print service 200, the physical printer ID, the user ID, and an entry including the expiration time set in S12. When the expiration time arrives, the lock setting is canceled (S17), and the logical printer is deleted (S18). The lock setting may be canceled by, for example, the deletion of an entry for which the expiration time has expired from the lock management table.

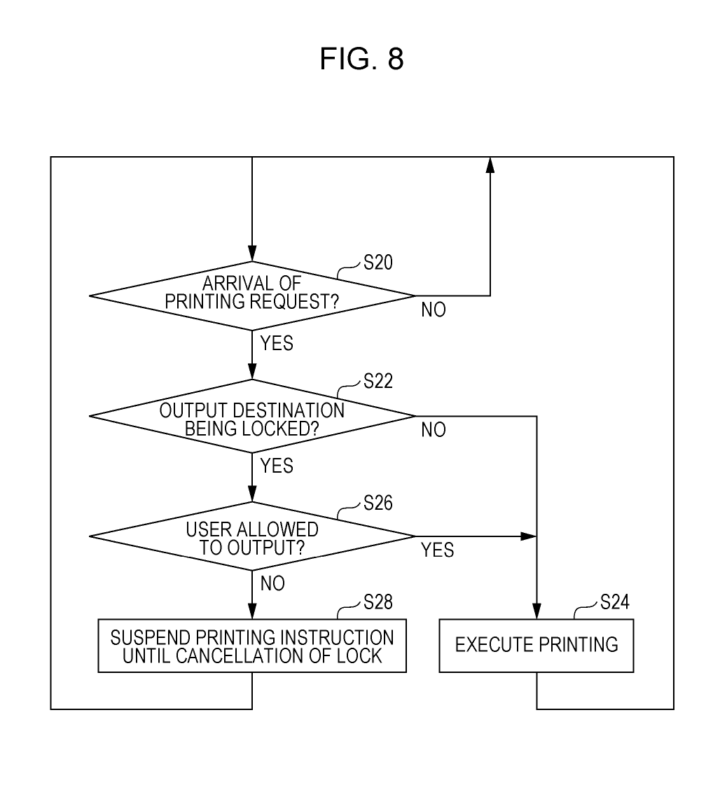

FIG. 8 illustrates an example of the procedure for a user print instruction reception process of the cloud print service 200 according to the second exemplary modification.

In the procedure illustrated in FIG. 8, the cloud print service 200 waits for the arrival of a print instruction given by any user (S20). When a print instruction arrives, the cloud print service 200 determines whether the physical printer ID of the output destination specified in the print instruction has been locked, by referring to, for example, the lock management table (S22). If the physical printer ID of the output destination has not been locked, the cloud print service 200 provides print data to the image forming device 100 associated with the physical printer ID of the output destination in accordance with the print instruction to cause the image forming device 100 to execute printing (S24) (see process steps (4) to (6) of FIG. 2). If it is determined in S22 that the physical printer ID of the output destination has been locked, it is determined whether or not the user who has issued the print instruction is a user who is authorized to output print data from the image forming device 100 having the physical printer ID of the output destination (S26). In this determination, if the user ID of the user who has issued the print instruction is equal to the user ID included in the lock setting associated with the physical printer ID of the output destination, it is determined that the user is authorized to output print data (if the determination result is YES). In this case, in S24, the cloud print service 200 executes a print instruction. If the determination result in S26 is NO, the cloud print service 200 saves the print instruction as a suspended print instruction (S28). The cloud print service 200 periodically checks each suspended print instruction as to whether, for example, the lock setting for the physical printer ID of the output destination included in the print instruction has been canceled. Upon detection of the cancellation of the lock setting, the cloud print service 200 executes the print instruction. Either of the determinations of S22 and S26 may be performed first.

In the example in FIG. 8, a print instruction given by another user to designate the image forming device 100, which is being locked, as the output destination is suspended. However, this is merely an example. Alternatively, a print instruction given by another user to designate the image forming device 100, which is being locked, as the output destination may be rejected.

After the completion of a print job of a user who locked the image forming device 100, if the lock setting is not canceled even after the user left the image forming device 100, other users are prevented from using the image forming device 100 until the lock setting is canceled by the arrival of the expiration time or the like. To address such an inefficient situation, the cloud print service 200 may send print data of the user who locked the image forming device 100 to the image forming device 100 and, in response to receipt of a new setting request of the temporary printer settings after the image forming device 100 notifies the cloud print service 200 of the completion of the output of the print data, automatically cancel the lock setting so as to accept the setting request. Accordingly, after the user who applied the lock setting picked up their printout and left the image forming device 100, any other user may be able to use the image forming device 100 even if the lock setting is not canceled. In this case, no new setting requests are accepted for a period from when the image forming device 100 was locked to when the printing operation of the user who applied the lock setting has been completed.

A third exemplary modification will now be described. This exemplary modification provides a mechanism for limiting a person who is allowed to temporarily use the image forming device 100 via the cloud print service 200 to the user of the mobile terminal 500 who has provided an access token to the image forming device 100 via short-range contactless communication such as NFC.

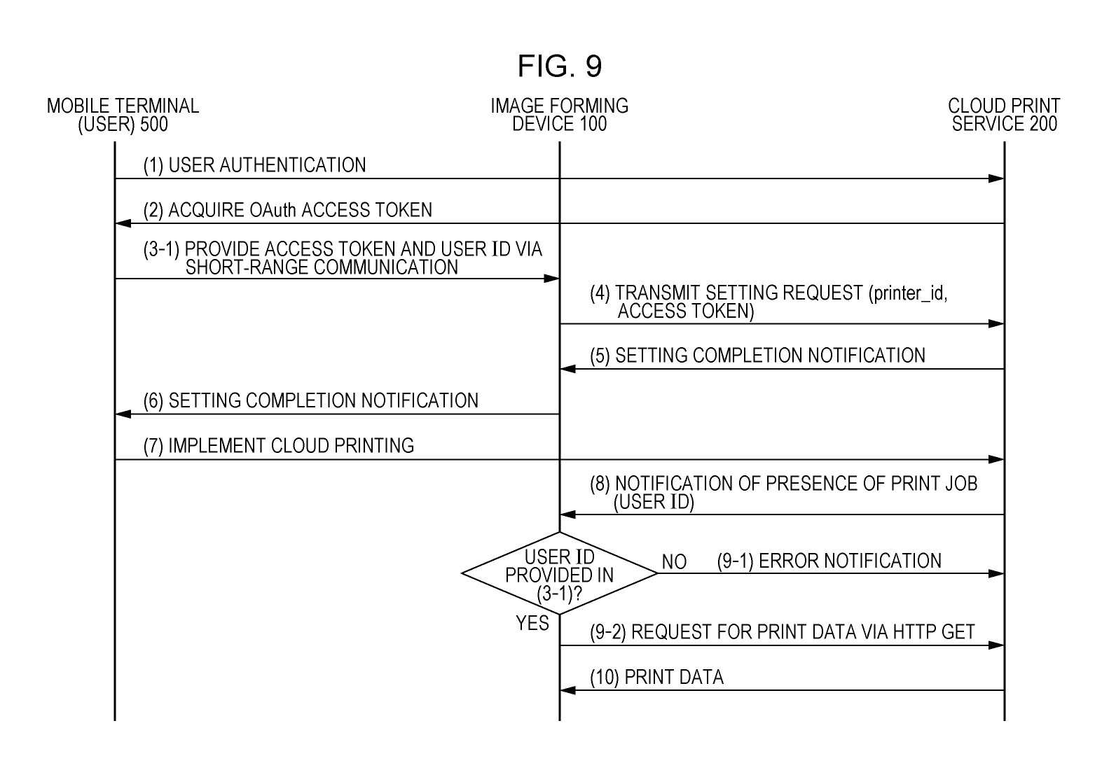

FIG. 9 illustrates an example of the flow of a process according to the third exemplary modification. In FIG. 9, process steps similar to process steps illustrated FIG. 2 are assigned the same numerals, and will not be described in detail.

This exemplary modification may be implemented when the image forming device 100 and the mobile terminal 500 each have a communication unit configured to communicate information in two ways, such as NFC.

In the illustrated process, after an access token is acquired process steps (1) and (2), in process step (3-1), the mobile terminal 500 notifies the image forming device 100 of the access token and the user ID of the user of the mobile terminal 500 in the cloud print service 200. The image forming device 100 stores the notified user ID. The stored user ID serves as “booking information” indicating that the image forming device 100 will be used with the user ID later. After that, process steps (4) to (7) are similar to those illustrated in FIG. 2. In accordance with the print instruction in process step (7), in process step (8), when the cloud print service 200 notifies the image forming device 100 of the presence of a print job in which the image forming device 100 is designated as the output destination, and also of, in this exemplary modification, the user ID of the user who has issued the print instruction. Upon receipt of the notification, the image forming device 100 determines whether or not the user ID received in process step (8) matches the user ID provided from the mobile terminal 500 in process step (3-1) and stored. If both do not match, in process step (9-1), the image forming device 100 sends an error notification indicating that the print job is not acceptable to the cloud print service 200. Upon receipt of the error notification, the cloud print service 200 stops transmitting the print data to the image forming device 100, and notifies the user who has sent the print instruction that the user is not authorized to print or output print data from the image forming device 100. If both match, in process step (9-2), the image forming device 100 requests the cloud print service 200 to transmit print data using an HTTP GET request. In process step (10), the print data is transmitted from the cloud print service 200 to the image forming device 100 in accordance with the request.

Accordingly, the image forming device 100 prints the print data onto a sheet of paper. In the illustrated example, since the image forming device 100 knows the user ID (the user ID in the cloud print service 200) of the user who has issued an instruction to print the print data, the user ID may be recorded in the current print log (processing history) information as information concerning the user who has issued the print instruction.

In the case of the method in which print data is transmitted from the cloud print service 200 to the image forming device 100 using the push mode without sending a message such as an XMPP message in process step (8), the cloud print service 200 may transmit the user ID to the image forming device 100 together with the print data. If the user ID matches the user ID notified by the mobile terminal 500 in process step (3-1), the image forming device 100 prints the print data, and does not print the print data otherwise.

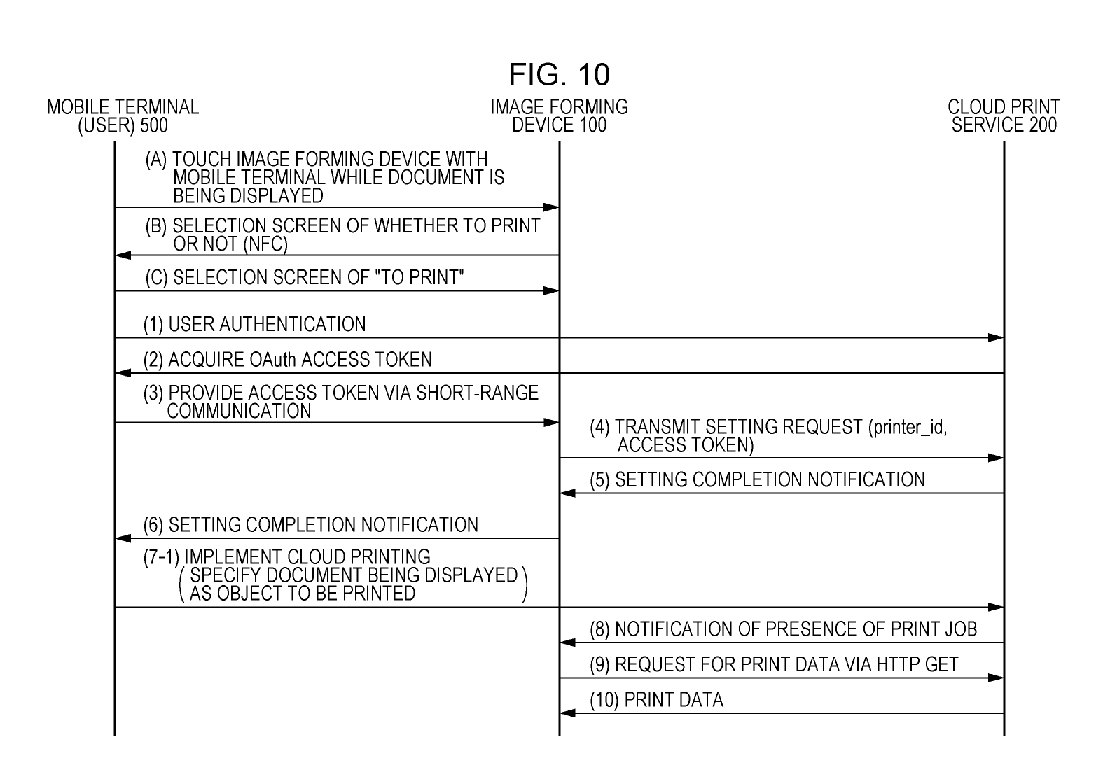

A fourth exemplary modification will be described with reference to FIG. 10.

In the fourth exemplary modification, the mobile terminal 500 on which a document is opened and displayed is placed near the reader/writer unit of the image forming device 100, allowing the document to be printed or output from the image forming device 100 via the cloud print service 200. That is, in the examples described above, after the image forming device 100 is temporarily set as the output destination, the document to be printed is selected from the cloud repository service 300 or the like. In this exemplary modification, in contrast, a document being viewed or edited by a user on the mobile terminal 500 is automatically designated as the object to be printed, removing the selection operation.

This exemplary modification provides a situation where a user opens a document using an application (for example, a document editing application) having a function to display a document that may be an object to be printed on the mobile terminal 500 and views or edits the document being displayed on the screen. As illustrated in process step (A) in FIG. 10, in this state, the user places the mobile terminal 500 near the reader/writer unit of the image forming device 100. Then, in process step (B), the image forming device 100 detects the mobile terminal 500, and sends a selection screen for selecting whether or not to perform printing to the mobile terminal 500 via NFC. Then, the mobile terminal 500 displays the selection screen, and the user inputs a result of the selection of whether or not to perform printing to the selection screen. The selection result input by the user is transferred from the mobile terminal 500 to the image forming device 100 via NFC.

If the selection result indicates “not to print”, the image forming device 100 does not perform any operation, and the process for the current NFC communication ends.

If the selection result indicates “to print”, the mobile terminal 500 starts the temporary printer setting function described above, and, in process step (C), notifies the image forming device 100 of the selection result of “to print” via NFC.

In process step (1), if the selection of “to print” has been made in process step (B), the cloud print app 510 of the mobile terminal 500 is started, and the cloud print app 510 accesses the cloud print service 200 to request and undergo user authentication. For example, in response to the notification in process step (C), the image forming device 100 may send a response to the mobile terminal 500, and the cloud print app 510 may be started in accordance with the response to perform a user authentication process. After the user authentication, through process steps (2) to (6), similarly to the flow illustrated in FIG. 2, the mobile terminal 500 acquires an access token from the cloud print service 200, and provides the access token to the image forming device 100. The image forming device 100 uses the access token to perform temporary printer settings for the cloud print service 200.

In process step (7-1), upon receipt of the notification of the completion of the temporary printer settings, the mobile terminal 500 accesses the cloud print service 200, and designates the document being opened on the application described above as the object to be printed, and sends an instruction to execute printing. In this case, the mobile terminal 500 may send identification information that identifies the document, such as URL, to the cloud print service 200, or send the data of the document. For example, if the document being opened on the application is a document in the cloud repository service 300, the mobile terminal 500 acquires information identifying the document, such as URL, from the cloud repository service 300, and notifies the cloud print service 200 of the identification information. If the document is being edited on the application, the mobile terminal 500 may once save the document in the cloud repository service 300, and then notify the cloud print service 200 of the URL of the document. If a document in the file system of the mobile terminal 500 is being displayed on the application, the data of the document may be transmitted to the cloud print service 200 in association with the print instruction.

When in process step (7-1), the cloud print app 510 accesses the cloud print service 200 to make a print instruction, if there are multiple logical printers 210 that the user is authorized to use (i.e., logical printers that have registered the user as an administrator or a sharer) in the cloud print service 200, for example, a list of usable logical printers 210 is provided from the cloud print service 200 to the cloud print app 510, and the user selects a logical printer 210 associated with the image forming device 100 that the user will use from the list.

The mobile terminal 500 may acquire a physical printer ID from the image forming device 100 during a certain event such as the initial touch operation in process step (1). Then, when accessing the cloud print service 200 using the cloud print app 510 in process step (7-1), the mobile terminal 500 may notify the cloud print service 200 of the physical printer ID to allow the cloud print service 200 to automatically select the logical printer 210 associated with the physical printer ID.

The cloud print service 200 generates print data of the document in accordance with the print instruction, and provides the print data to the image forming device 100 through process steps (8) to (10) illustrated in FIG. 10. Process steps (8) to (10) illustrated in FIG. 10 may be similar to process steps (8) to (10) illustrated in FIG. 2.

In the process illustrated in FIG. 10, after process step (A), in process step (B), a selection screen of whether or not to perform printing is provided from the image forming device 100 to the mobile terminal 500 for user confirmation. However, such a confirmation process may be omitted. In a procedure without a confirmation process, when a user places the mobile terminal 500 on which a document is displayed near the image forming device 100 in process step (A), the mobile terminal 500 executes process steps (1) and (2) in response to the movement of the mobile terminal 500 as a trigger to acquire an access token, and provides the acquired access token to the image forming device 100.

The units configured to perform the information processing of the image forming device 100, the cloud print service 200, and the mobile terminal 500 described above by way of example are implemented by, for example, causing a general-purpose computer to execute a program indicating the processing of the respective functional modules of the devices. The term “computer”, as used herein, is used to include, for example, as hardware components, a circuit configuration in which a microprocessor such as a central processing unit (CPU), a memory (primary memory) such as a random access memory (RAM) and a read-only memory (ROM), a secondary memory controller for controlling a secondary memory such as a hard disk drive (HDD), a solid-state drive (SSD), and a flash memory, various input/output (I/O) interfaces, a network interface for controlling a connection with a wireless or wired network, and so forth are connected to one another via, for example, a bus. A disk drive for reading and/or writing data from and/or to a portable disk recording medium such as a compact disc (CD), a digital versatile disc (DVD), or a blu-ray disc, a memory reader/writer for reading and/or writing data from and/or to a portable non-volatile recording medium complying with various standards, such as a flash memory, and so forth may further be connected to the bus via, for example, an I/O interface. A program describing the content of the processes of the respective functional modules described above by way of example is saved in a secondary memory device such as a flash memory through a recording medium such as a CD or a DVD or via a communication unit such as a network, and is installed into a computer. The program stored in the secondary memory device is read onto a RAM, and is executed by a microprocessor such as a CPU, thereby allowing the functional modules described above by way of example to be implemented.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
an information processing device; and
an image forming device,
the information processing device including
an authentication request unit that requests an authentication of a user in a print service system using identification information identifying the user in the print service system and authentication information for authenticating the identification information identifying the user,
an authorization information acquisition unit that acquires, in response to success of the authentication, access authorization information associated with the identification information identifying the user from the print service system, and
a transfer unit that transfers the acquired access authorization information to the image forming device via short-range communication,
the image forming device including
a transmitting unit that transmits a setting request to the print service system to request the print service system to set a setting to allow a user associated with the access authorization information to use the image forming device, the setting request including the access authorization information transferred from the information processing device and identification information identifying the image forming device in the print service system.

2. The printing system according to claim 1, wherein the print service system includes
a setting unit that, in response to receipt of the setting request from the image forming device, sets setting information indicating that the user associated with the access authorization information included in the setting request is authorized to use the image forming device identified by the identification information identifying the image forming device included in the setting request, and
a print data transmitting unit that, in response to receipt of a print instruction given by a user associated with the setting information from the information processing device, the print instruction designating an image forming device indicated by the setting information as an output destination, transmits print data associated with the print instruction to the image forming device.

3. The printing system according to claim 2, wherein
the setting unit sets an expiration time in association with the setting information, and
in response to receipt of a print instruction given by the user associated with the setting information from the information processing device within the expiration time, the print instruction designating an image forming device indicated by the setting information as an output destination, the print data transmitting unit transmits print data associated with the print instruction to the image forming device.

4. The printing system according to claim 3, wherein the setting unit invalidates the setting information after the expiration time has passed.

5. The printing system according to claim 2, wherein the print service system includes
an invalidation unit that invalidates the setting information in response to completion of printing of the print data transmitted from the print data transmitting unit to the image forming device.

6. The printing system according to claim 2, further comprising:
a lock setting unit that sets a lock setting for the setting information set by the setting unit so that only the user is allowed to use the image forming device;
a cancellation unit that cancels the lock setting set by the lock setting unit in a case where a predetermined condition is satisfied; and
a controller that performs control so that, in response to receipt of a print instruction given by a user other than the user, the print instruction designating the image forming device as an output destination, print data associated with the print instruction is not transmitted to the image forming device for a period from when the lock setting is set to when the lock setting is cancelled.

7. The printing system according to claim 1, wherein the image forming device further includes
a receiving unit that receives the identification information identifying the user in the print service system from the information processing device in association with the access authorization information, and
a print data reception controller that performs control so as not to receive print data of a user other than the user identified by the identification information received by the receiving unit within print data to be transmitted from the print service system to the image forming device.

8. The printing system according to claim 1, wherein the information processing device further includes
a print instruction unit that sends a print instruction to the print service system, in a case where the authorization information acquisition unit acquires the access authorization information while a document is being displayed on a screen of the information processing device, to print the document.

9. An information processing device comprising:
an authentication request unit that requests an authentication of a user of the information processing device in a print service system using identification information identifying the user in the print service system and authentication information for authenticating the identification information;
an authorization information acquisition unit that acquires, in response to success of the authentication, access authorization information associated with the identification information from the print service system; and
a transfer unit that transfers the acquired access authorization information to an image forming device via short-range communication.

10. A non-transitory computer readable medium storing a program causing an information processing device to execute a process, the process comprising:
requesting an authentication of a user of the information processing device in a print service system using identification information identifying the user in the print service system and authentication information for authenticating the identification information;
in response to success of the authentication, acquiring access authorization information associated with the identification information from the print service system; and
transferring the acquired access authorization information to an image forming device via short-range communication.

11. An image forming device configured to cooperate with an information processing device, comprising:
a transmitting unit that transmits a setting request to a print service system, the setting request including access authorization information transferred from the information processing device, and identification information identifying the image forming device in the print service system,
wherein the information processing device includes
an authentication request unit that requests user authentication in a print service system using identification information identifying a user in the print service system and authentication information for authenticating the identification information,
an authorization information acquisition unit that acquires the access authorization information in response to success of the authentication, the access authorization information being associated with the identification information from the print service system, and
a transfer unit that transfers the acquired access authorization information to the image forming device via short-range communication.

12. An image forming device configured to be connected to an information processing device and a print service system, comprising:
a receiving unit that receives, from the information processing device, access authorization information issued by the print service system and identification information identifying a user in the print service system, in association with each other;
a transmitting unit that transmits the received access authorization information and image forming device identification information identifying the image forming device to the print service system; and
a print data reception controller that performs control so as not to receive print data of a user other than the user identified by the identification information received by the receiving unit within print data to be transmitted from the print service system to the image forming device.
